(19) United States
(12) Patent Application Publication
(10) Pub. No.: US 2003/0092378 A1
(43) Pub. Date: May 15, 2003

(54) Information monitoring system using wireless interconnecting device

(76) Inventor: Kazuhiko Satoh, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/078,168

(22) Filed: Feb. 19, 2002

(30) Foreign Application Priority Data
Nov. 12, 2001 (JP) 2001-345798

(51) Int. Cl. H04B 7/15

(52) U.S. Cl. 455/11.1; 455/16

(57) ABSTRACT

Each athlete wears an individual information obtaining device 51 around his/her wrist and thereby, data on his/her heartbeat and blood pressure is obtained while the data on the heartbeat and so on, with time information and an athlete's registration number being added thereto by a data processing section 52, is packet-transferred to a wireless interconnecting device 2 in a competition headquarter from a terminal equipment 14 via wireless interconnecting devices 1-1 to 1-n and collected in an administrative server 4 connected to this wireless interconnecting device 2 so that the data is processed in an administrative computer 5.

### BACKGROUND OF THE INVENTION

1. Field of the Invention

The present invention relates to a information monitoring system using a wireless interconnecting device for managing health, competition data, and so on of participants in sport events, and particularly for realizing efficient health management for participants in sport events, efficient back-up given to them, and so on.

2. Description of the Related Art

In accordance with enhancement of a so-called desire for health in recent years, more people spend their leisure time in enjoying sport and they enjoy various kinds of sports. In enjoying such various sports, it is an important issue for further enjoying the sports and for participants' health how so-called sport information such as various data on time and the like and various data on participants' physical conditions and the like during the events should be managed.

The sport information mentioned here includes, taking a marathon road race, for example, information on start time, information obtained when each runner passes specific points during the race, information on the time each participant reaches a goal, and so on.

As a method used for obtaining the above information, for example, in a marathon race and so on, the following system is conventionally used: in the system, a device, generally called a chip in which a wireless transmitter is buried in a resin member thereof and an eyelet for having a shoelace passed therethrough is formed, is attached on each participant's foot by having the shoelace of each participant's shoe pass through the eyelet, while data on the start time of each runner, data on the time each runner passes specific passing points, and the like are collected with the use of line-shaped sensors installed at a start, a goal, and a plurality of checkpoints and a totalization device connected to these line-shaped sensors.

In the chip used here with the wireless transmitter buried therein, a registration number determined for each participating runner is stored in advance, and when the runner steps on the line-shaped sensors installed at the start, the goal, and each of the checkpoints to pass these places, the registration number of the runner is wirelessly transmitted (for example, by electromagnetic induction) in a predetermined data format from this chip, and this transmitted signal is received by the line-shaped sensors which have a function as a receiving antenna as well as a function as a sensor and inputted to the totalization device connected to these line-shaped sensors. In the totalization device, the time when the data is received is stored for each registration number of the runner.

Incidentally, it is desired from the viewpoint of preventing an unexpected accident and so on to enable a competition organizer to manage sport information including information on participating runners' physiology as well as the purely competition data as described above, taking a marathon race, for example.

In a relatively small-scaled race of some kilometers, where arranging a sufficient number of lookouts is possible, an injured runner, a runner in a bad physical condition, and the like can be easily found and rescued during the race. However, in a race having many participating runners such as a 30 km race, a 20 km race, and a 10 km race as well as a so-called full marathon, which often have some tens of thousands participating runners, a problem has arisen that it becomes more difficult to monitor the runners from the viewpoint of managing their health as the distance the runners run becomes longer and the number of participating runners increases.

In a so-called road race and the like, since runners are not capable of recognizing their own physical conditions themselves before they actually run, they sometimes overestimate their physical conditions to run at a faster speed than they should, and as a result, it sometimes happens that they are not able to continue running to withdraw from the race halfway or their physical conditions suddenly get worse. To arrange the sufficient number of lookouts at relatively close intervals would make it possible to recognize each runner's condition and enable the lookouts to pay attention at a relatively early stage to a runner who is expected to withdraw from the race. However, it is practically impossible for all competitions to make such arrangement.

### SUMMARY OF TIE INVENTION

It is an object of the present invention to provide a sport information monitoring system using a wireless interconnecting device, a wireless interconnecting device for a sport information monitoring system, and an individual information obtaining device for a sport information monitoring system which realize efficient concentrated management of physiological data as well as competition data of participating athletes in a sport event.

It is another object of the present invention to provide a sport information monitoring system using a wireless interconnecting device, a wireless interconnecting device for a sport information monitoring system, and an individual information obtaining device for a sport information monitoring system which realize efficient management of sport information on participating athletes in a sport event and efficient management of the sport event and, furthermore, efficient support for managing participating athletes' health.

It is still another object of the present invention to provide a sport information monitoring system using a wireless interconnecting device, a wireless interconnecting device for a sport information monitoring system, and an individual information obtaining device for a sport information monitoring system which realize careful health management and accident prevention for all participants in a sport event.

It is yet another object of the present invention to provide a sport information monitoring system using a wireless interconnecting device, a wireless interconnecting device for a sport information monitoring system, and an individual information obtaining device for a sport information monitoring system which realize prompt detection of abnormal physical conditions of participants during and after they participate in a sport.

According to a first aspect of the present invention, provided is a sport information monitoring system using a wireless interconnecting device, comprising: an individual information obtaining device which is worn by an athlete, for obtaining individual information on the athlete; a plurality of wireless interconnecting devices for wirelessly interconnecting the individual information obtained by the individual information obtaining device; an administrative server for storing the individual information obtained by the individual information obtaining device via the plural wireless interconnecting devices; and an administrative computer for judging an activity condition of the athlete based on the individual information stored in the administrative server.

In this configuration, the individual information obtained by the individual information obtaining device can be assembled in the administrative server via the wireless interconnecting devices and an activity condition of each athlete can be judged in the administrative computer based on the assembled data, so that processing as required can be performed, which realizes efficient management of information on the participating athletes in a sport event and efficient management of the sport event.

According to a second aspect of the present invention, provided is a wireless interconnecting device used for a sport information monitoring system for obtaining and monitoring individual information on each participant in a sport, and the wireless interconnecting device is realized by a wireless access point to be an element constituting a wireless LAN.

According to a third aspect of the present invention, provided is an individual information obtaining device used for a sport information monitoring system for obtaining and monitoring individual information on a participant in a sport, comprising a sensor for obtaining physiological information on the participant.

### BRIEF DESCRIPTION OF THE DRAWINGS

FIG. 1 is a block diagram showing a whole configuration of a sport information monitoring system in an embodiment of the present invention;

FIG. 2 is a schematic view schematically showing a state in which a wireless interconnecting device is installed when the sport information monitoring system is applied to a road race marathon in the embodiment of the present invention;

FIG. 3 is a block diagram showing a configuration example of an individual information obtaining device in the embodiment of the present invention;

FIG. 4 is a block diagram showing a configuration example of a data processing section in the embodiment of the present invention;

FIG. 5 is a block diagram showing another configuration example of the data processing section;

FIG. 6 is a block diagram showing a connection configuration of an administrative server and an administrative computer in the embodiment of the present invention;

FIG. 7 is a schematic table schematically showing a storage state of data on heartbeat and passing time of each runner stored in a time sequential order in the administrative server in the embodiment of the present invention;

FIG. 8 is a schematic table schematically showing a storage state of data on blood pressure and passing time of each runner stored in a time sequential order in the administrative server in the embodiment of the present invention;

FIG. 9 is a subroutine flow chart showing a procedure for monitoring processing executed by the administrative computer in the embodiment of the present invention; and

FIG. 10 is a subroutine flow chart showing a procedure for notification processing executed by a terminal equipment in the embodiment of the present invention.

### DETAILED DESCRIPTION OF THE PREFERRED EMBODIMENTS

The present invention will be hereinafter described in detail with reference to the drawings.

Incidentally, it is to be understood that the present invention is not intended to be limited to members, dispositions, and so forth which will be described below, and various modifications and improvements may be made therein without departing from the spirit of the present invention.

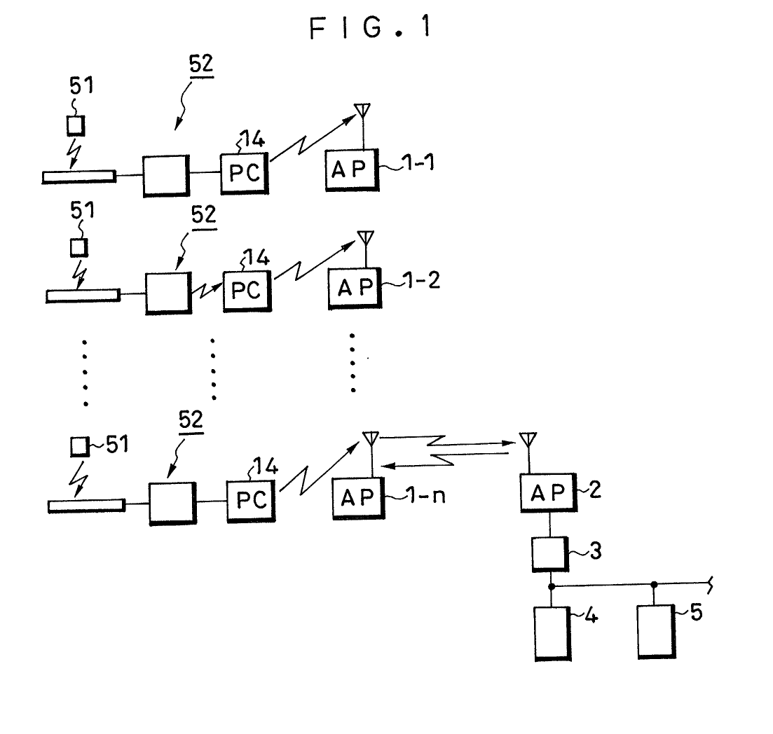

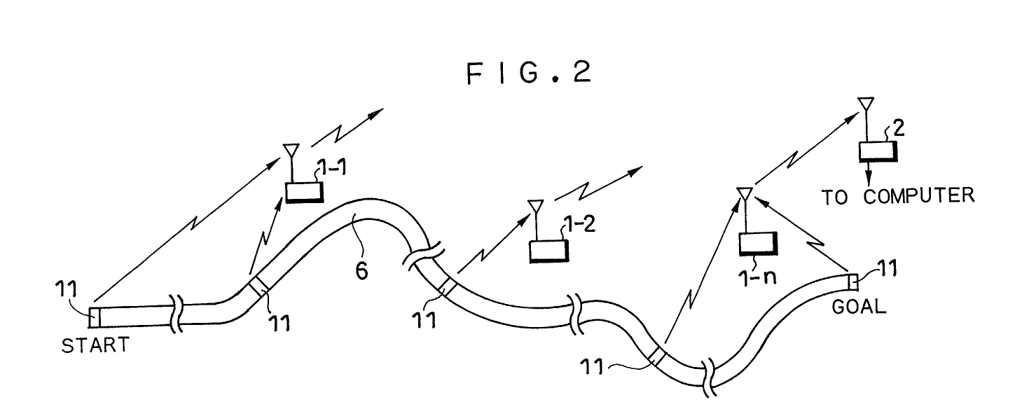

First, a whole configuration of a sport information monitoring system using a wireless interconnecting device in an embodiment of the present invention is described with reference to FIG. 1 and FIG. 2.

The sport information monitoring system using the wireless interconnecting device in the embodiment of the present invention is a configuration example when it is applied to a marathon race (road race) and this sport information monitoring system is composed of an individual information obtaining device 51 worn by each participating runner, a plurality of wireless interconnecting devices 1-1 to 1-n installed in a plurality of checkpoints (denoted by ‘AP’ in FIG. 1), a data processing section 52 for transmitting individual information (data) obtained by the individual information obtaining device 51 to a nearby wireless interconnecting device out of the wireless interconnecting devices 1-1 to 1-n and for executing processing and so on in response to the receipt of abnormal information from a competition headquarter, a wireless interconnecting device 2 installed in the competition headquarter (denoted by ‘AP’ in FIG. 1), a router 3, an administrative server 4, and an administrative computer 5 (refer to FIG. 1).

To explain first, in the road race, participants run, for example, from a predetermined place designated as a start point (denoted by ‘START’ in FIG. 2) to a place designated as a goal point (denoted by ‘GOAL’ in FIG. 2), as shown in FIG. 2.

Line-shaped sensor/antennas (detailed later) 11 are installed at the start point, the goal point, and predetermined plural checkpoints in a manner that they lie across a road 6 and the plural wireless interconnecting devices 11 to 1-n are installed at appropriate intervals while the wireless interconnecting device 2 is also installed in the competition headquarter (refer to FIG. 2).

Next, each of elements constituting the sport information monitoring system according to the embodiment of the present invention is specifically explained.

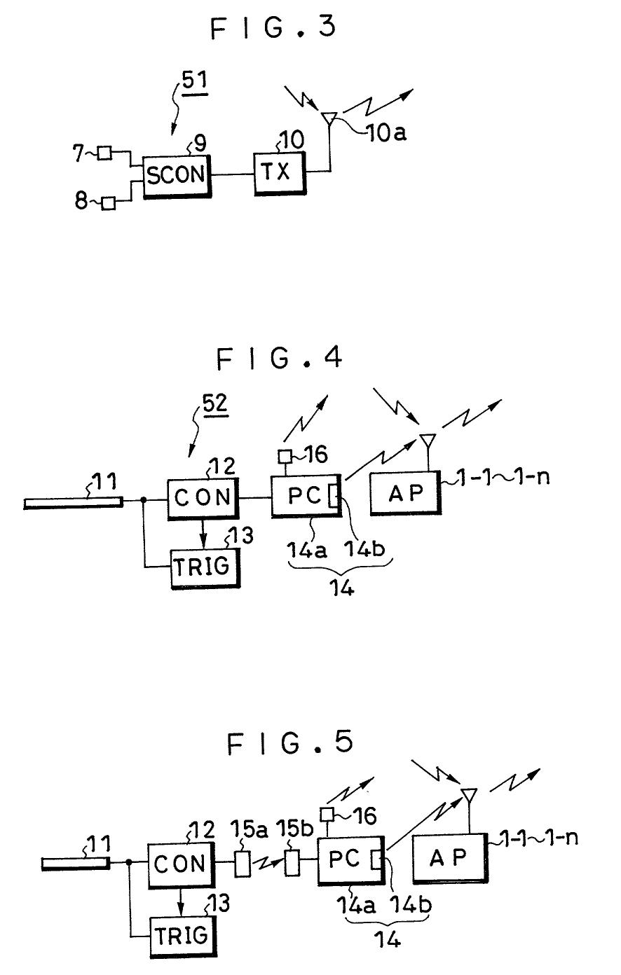

Firstly, the individual information obtaining device 51 is composed of a heartbeat sensor 7, a blood pressure sensor 8, a sensor signal converter (denoted by ‘SCON’ in FIG. 3) 9 for converting output signals of these two sensors 7 and 8 to signals appropriate for being sent out to the outside, and a transmitter (denoted by ‘TX’ in FIG. 3) 10 as its main constituting elements (refer to FIG. 3). The individual information obtaining device 51 in the embodiment of the present invention is structured with its case (not shown) formed in a wristwatch shape and accommodating the above-mentioned heartbeat sensor 7 and so on therein so that it can be worn around the participating runners' wrists for use similarly when they wear wristwatches.

The heartbeat sensor 7 and the blood pressure sensor 8 have generally and conventionally known structures and are provided in positions where they can touch the skin of the runners.

The transmitter 10 in the embodiment of the present invention is structured to transmit a signal by electromagnetic induction to each of the line-shaped sensor/antennas 11, which are described later, installed at the start point and so on.

The sensor signal converting section 9 is structured to convert detected signals of the heartbeat sensor 7 and the blood pressure sensor 8 to a signal format so that it is appropriate for being inputted to the transmitter 10 and input the converted signal to the transmitter 10. Furthermore, a registration number of the participating runner wearing the individual information obtaining device 51 is stored in this sensor signal converting section 9, which is structured to convert this registration number to a predetermined signal format and input it to the transmitter 10 together with data obtained by the heartbeat sensor 7 and the blood pressure sensor 8.

The transmitter 10, to which an antenna 10a accommodated in the individual information obtaining device 51 is connected, applies a transmission signal to this antenna 10a. To be specific, the antenna 10a is structured to be a coil in the embodiment of the present invention, which facilitates electromagnetic induction with the line-shaped sensor/antennas 11.

Moreover, the transmitter 10 in the embodiment of the present invention is structured to apply to the antenna 10a a signal corresponding to heartbeat and blood pressure data together with a registration number of the runner when a trigger signal for starting transmission is sent out from a later-described trigger generator 13 and this signal is induced in the antenna 10a via electromagnetic induction with the line-shaped sensor/antenna 11.

Next, the data processing section 52 is composed of the sensor/antenna 11, a signal converter (denoted by ‘CON’ in FIG. 4) 12, the trigger generator (denoted by ‘TRIG’ in FIG. 4) 13, and a terminal equipment (denoted by ‘PC’ in FIG. 4) 14 (refer to FIG. 4).

First, the sensor/antenna 11 is structured by integrally joining a pressure sensor (not shown) formed in a line shape and a coil antenna (not shown) made of a conductive member whose whole structure is formed in a line shape and is laid on the ground for use. This sensor/antenna 11 is structured to output a signal according to the pressing pressure when a runner steps on its pressure sensor portion, while being structured to output the aforesaid trigger signal to the individual information obtaining device 51 worn around the wrist of each runner and receive the signal from the individual information obtaining device 51 by electromagnetic induction. Note that it is preferable that this sensor/antenna 11 is laid over a width in a running direction wide enough to prevent the runner from jumping over it and to make sure the runner steps on it when he passes it.

The sensor/antenna 11 as structured above is connected to the signal converter 12 and the trigger generator 13 which are installed near it.

The signal converter 12 is structured to convert the signal corresponding to the heartbeat and blood pressure data and the registration number of the runner which are received by the sensor/antenna 11 by electromagnetic induction to a signal so that the signal is appropriate for being inputted to the terminal equipment 14. Furthermore, when the sensor/antenna 11 is stepped on by the runner passing it and the detected signal is outputted from its pressure sensor portion to be inputted to the signal converter 12, the signal converter 12 is structured to output a control signal for trigger generation to the trigger generator 13 and input this control signal to the later-described terminal equipment 14 as a signal for recording the time. An output stage of the signal converter 12 as structured above is connected to the terminal equipment 14 by cable connection.

When the control signal which is outputted in response to the runner's stepping on the sensor/antenna 11 is inputted from the signal converter 12, the trigger generator 13 is structured to apply the signal to the sensor/antenna 11. When the signal is applied to the sensor/antenna 11 by the trigger generator 13, an induction signal is generated by electromagnetic induction in the antenna 10a which is connected to the transmitter 10 of the individual information obtaining device 51. Then, as previously described, when this induction signal is received, the transmitter 10 is structured to apply a signal corresponding to the heartbeat and blood pressure data and the registration number of the runner to the antenna 10a.

Incidentally, connection between the signal converter 12 and the terminal equipment 14 does not need to be limited to cable connection and it may of course be wireless connection as shown in FIG. 5.

More specifically, in FIG. 5, a wireless transmitting adapter 15a for wirelessly transmitting an output signal of the signal converter 12 is connected to the signal converter 12 and a wireless receiving adapter 15b for receiving the radio signal transmitted from the wireless transmitting adapter 15a and inputting this signal to the terminal equipment 14 is connected to the terminal equipment 14.

Next, the terminal equipment 14 is an equipment for transmitting the signal which is inputted through a cable or radio line from the signal converter 12 to the wireless interconnecting devices 1-1 to 1-n in a predetermined signal format and also has a function of sending out information on abnormality to cellular phones which lookouts carry with them when information on a runner's abnormal physical condition is transmitted from the competition headquarter via the wireless interconnecting device 2 as described later.

To be specific, the terminal equipment 14 as structured above is realized by a personal computer 14a and a NIC (Network Interface Card) 14 connected to the personal computer 14a and having a wirelessly transmitting/receiving function and particularly, it is preferable that the personal computer 14a is a portable type personal computer.

Furthermore, the terminal equipment 14, to which the signal corresponding to the runner's stepping on the sensor/antenna 11 is inputted from the signal converter 12 as described above, is structured to store the time of an instant when this signal is inputted thereto since the instant when this signal is inputted thereto corresponds to an instant when the runner passes the point where the sensor/antenna 11 is installed. The terminal equipment 14 is structured to add this stored time to the signal corresponding to the heartbeat and blood pressure data and the registration number of the runner which is thereafter inputted thereto via the signal converter 12 and transmit the signal to the wireless interconnecting devices 1-1 to 1-n.

Moreover, a telephone adapter 16 is connected to the terminal equipment 14 in the embodiment of the present invention to enable e-mail transmission to pre-registered cellular phones of the lookouts as described later. This telephone adapter 16 is a generally and conventionally known adapter which establishes a communication line with a nearby base station for cellular phones (not shown), similarly to cellular phones, and enables connection with a public telephone network.

The wireless interconnecting devices 1-1 to 1-n disposed at appropriate intervals between the start point and the goal point have basically the same structure and function as those of the wireless interconnecting device 2 installed in the competition headquarter.

The number of the wireless interconnecting devices 1-1 to 1-n installed may correspond to the number of the sensor/antennas 11, namely, the terminal equipments 14, or may be one for every plural terminals 14 as long as communication is possible.

To be specific, these wireless interconnecting devices 1-1 to 1-n and 2 are appropriately those which are based on, for example, the international standard IEEE802.11 and 802.11b defined by IEEE (Institute of Electrical and Electronics Engineers) and they are generally called wireless access points or simply, access points.

It is appropriate that the wireless interconnecting devices 1-1 to 1-n and 2 as structured above are installed in a manner that parts of communication ranges of adjoining wireless interconnecting devices overlap each other to enable packet transfer as described next.

In this way, the registration number, the heartbeat and blood pressure data and the passing time of the runner sent to the wireless interconnecting devices 1-1 to 1-n from the terminal equipments 14, namely, the individual information data, are sent to the wireless interconnecting device 2 installed in the competition headquarter by a generally and conventionally known packet transfer function which the same kind of wireless interconnecting devices as the wireless interconnecting devices 1-1 to 1-n usually have.

In other words, for example, the wireless interconnecting device 1-1 installed near the start point is not capable of directly exchanging packets with the wireless interconnecting device 2 installed in the competition headquarter due to its wireless communication capacity. However, a packet signal transmitted from the wireless interconnecting device 1-1 is received by the adjoining wireless interconnecting device 1-2 installed with a part of its communication range overlapping that of the wireless interconnecting device 1-1, undergoes transfer processing here, and is further transferred in sequence to an adjoining wireless interconnecting device so that the wireless interconnecting device 2 installed in the competition headquarter is capable of receiving the packet from the wireless interconnecting device 1-1 with which the wireless interconnecting device 2 cannot directly exchange packets.

In the embodiment of the present invention, a so-called wireless LAN (Local Area Network) is formed by the aforesaid terminal equipments 14 and the wireless interconnecting devices 1-1 to 1-n and 2.

Next, the structures of the wireless interconnecting device 2 installed in the competition headquarter and the administrative server 4 and so on connected thereto are explained.

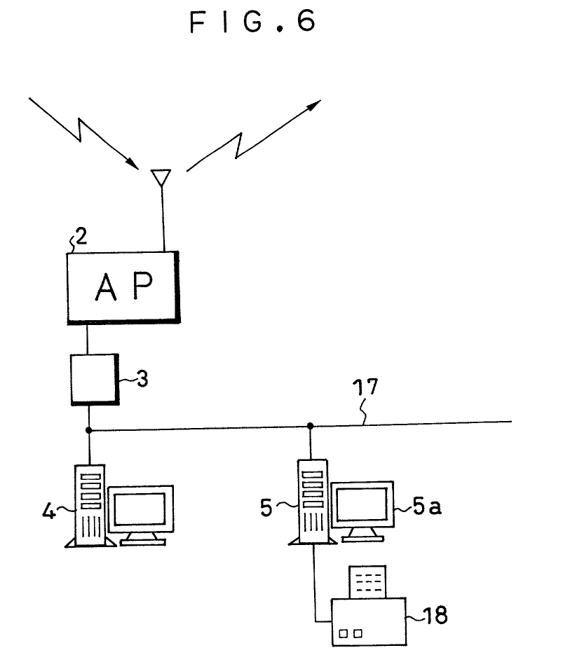

The router 3 is connected to the wireless interconnecting device 2, and the administrative server 4 and the administrative computer 5 are connected to this router 3 via a LAN backbone line 17 (refer to FIG. 6). A client terminal, though not shown, may further be connected to the LAN backbone line 17 when necessary. In this way, a so-called wired LAN is connected to the wireless interconnecting device 2 installed in the competition headquarter, which enables the wired LAN to exchange packets to/from the aforesaid wireless LAN formed by the wireless interconnecting devices 1-1 to 1-n and the terminal equipments 14 corresponding to the wireless interconnecting devices 1-1 to 1-n respectively.

The administrative server 4 is structured to store and administrate the individual information packet-transferred by the wireless interconnecting devices 1-1 to 1-n.

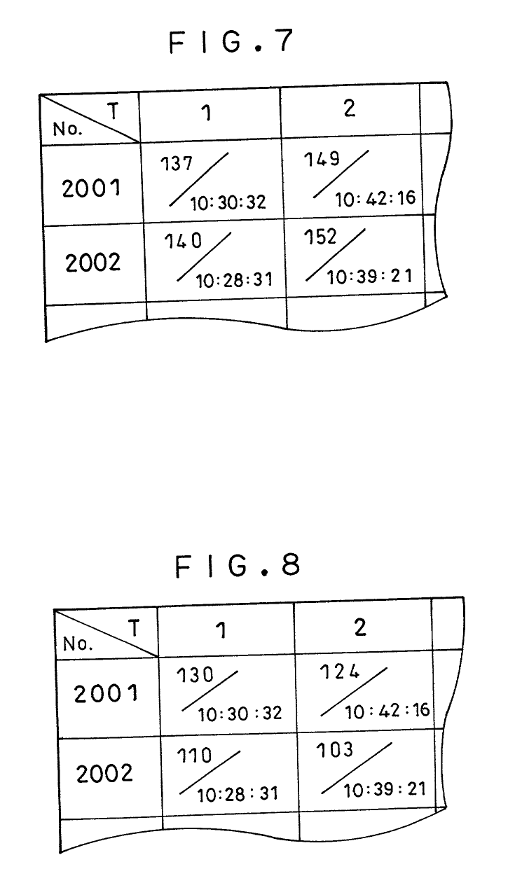

In other words, specifically, a packet is transferred to the wireless interconnecting device 2 by the wireless interconnecting devices 1-1 to 1-n every time each of the participating runners passes the sensor/antenna 11, and data inputted to the administrative server 4 via the wireless interconnecting device 2 and the router 3 is stored in a time sequential order, for example, as shown in FIG. 7 and FIG. 8, being classified into the heartbeat data and the blood pressure data for each of the registration numbers of the runners.

In FIG. 7 and FIG. 8, a column with ‘No.’ written therein is a region where the registration numbers of the runners are stored while in a row with ‘T’ written therein, an order the data is obtained is shown, with the numbers 1, 2, . . . written therein for convenience sake in an ascending order from data obtained at earlier time. For example, referring to a row in which a registration number 2001 is written in FIG. 7, data written in a column corresponding to T=1 is data which is obtained first in terms of time sequence. The heartbeat data and time when it is obtained are stored there. Specifically, ‘137’ indicates a cardiac rate and ‘10:30:32’ indicates that it is obtained at 10:30:32 am.

Similarly, in FIG. 8, referring to data for a runner with a registration number of 2002 obtained at the instant T=1, the maximum blood pressure and the time it is obtained are shown as 110 and 10:28:31 am respectively.

Moreover, past data on heartbeat and blood pressure when a runner is in a healthy condition (normal time) is stored beforehand in the administrative server 4 correspondingly to his registration number.

The administrative computer 5 is structured to judge abnormality in heartbeat or blood pressure of the runner and executes processing for notifying the abnormality to the lookouts via the wireless interconnecting devices 1-1 to 1-n as described later when abnormality is detected, and in addition, it is structured to be capable of immediately performing processing of printing race completion certificates and the like via a printer 18 connected thereto (refer to FIG. 6), as in a general practice.

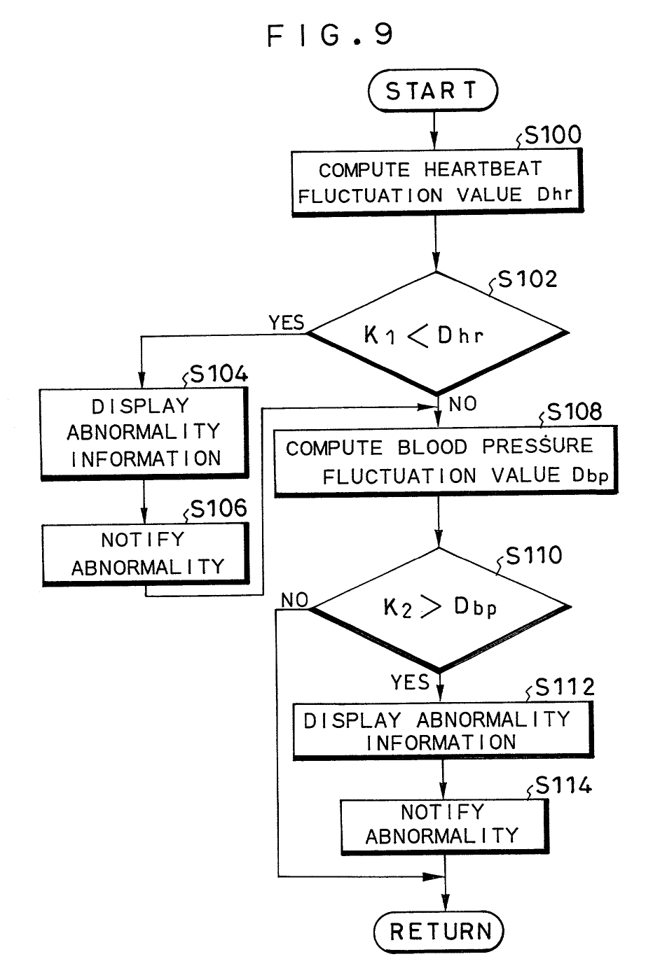

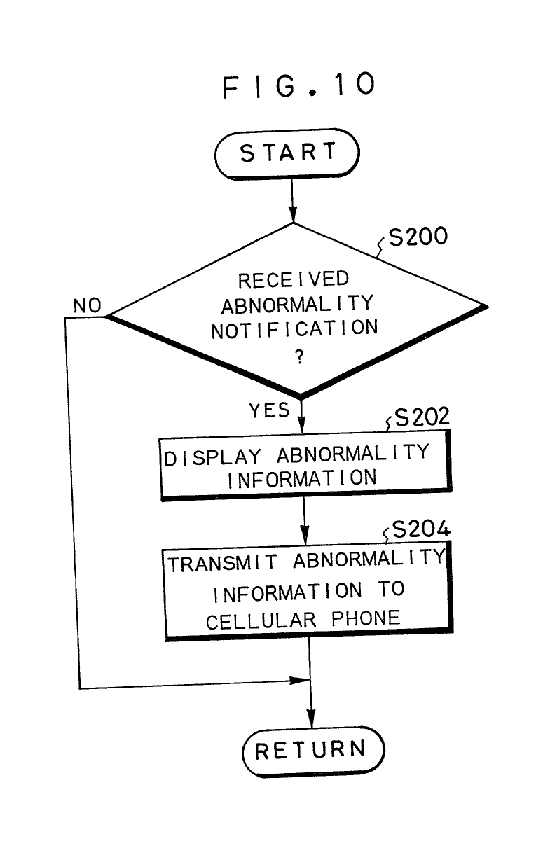

Next, the operation in the structure described above is explained with reference to subroutine flow charts shown in FIG. 9 and FIG. 10.

First, monitoring processing executed in the administrative computer 5 is explained with reference to FIG. 9.

In this processing, which is performed for each runner, a fluctuation value in the cardiac rate is computed for a first runner (usually, in the order of the registration numbers) when the processing is started (refer to Step S100 in FIG. 9). More specifically, the administrative computer 5 reads from the administrative server 4 two latest heartbeat data of the runner and computes a difference Dhr between them.

Next, it is judged whether or not the computed difference Dhr in the heartbeat data exceeds a specific difference K₁ which is stored in advance as a limit value for the subject runner (refer to Step S102 in FIG. 9). When it is judged that the difference Dhr in the heartbeat data does not exceed the specific value K₁ (in a case of NO), the procedure proceeds to processing in later-described Step S108. Meanwhile, when it is judged that the difference Dhr in the cardiac rate exceeds the specific value K₁ in Step S102 (in a case of YES), which signifies abnormality, abnormality in heartbeat together with the registration number of the runner is displayed (abnormality information display) on a display device 5a of the administrative computer 5 (refer to Step S104 in FIG. 9).

Subsequently, in Step S106, the content of this abnormality information display is transmitted and notified via the wireless interconnecting device 2 to the other wireless interconnecting devices 1-1 to 1-n and the procedure proceeds to Step S108.

In Step S108, the fluctuation value in blood pressure is computed. More specifically, the administrative computer 5 reads from the administrative server 4 two latest blood pressure data of the runner for whom the fluctuation value in the heartbeat is previously computed and computes a difference Dbp between them.

Next, it is judged whether or not the computed difference Dbp in blood pressure exceeds a specific difference K₂ which is stored in advance as a limit value for the subject runner (refer to Step S110 in FIG. 9). When it is judged that the difference Dbp in blood pressure does not exceed the specific value K₂ (in a case of NO), this subroutine processing is finished for the moment. Meanwhile, when it is judged that the difference Dbp in blood pressure exceeds the specific value K₂ (in a case of YES), which signifies abnormality, similarly to the case of the heartbeat abnormality, abnormality in blood pressure together with the registration number of the runner is first displayed (abnormality information display) on the display device 5a of the administrative computer 5 (refer to Step S112 in FIG. 9).

Next, after the content of this abnormality information display is transmitted and notified via the wireless interconnecting device 2 to the other wireless interconnecting devices 1-1 to 1-n (refer to Step S114 in FIG. 9), the subroutine processing is finished for the moment and the procedure returns to a not-shown main routine. Incidentally, after other processing is executed in the main routine, this subroutine is resumed to start executing similar processing from Step S100 for a next runner.

The notification processing executed in each of the terminal equipments 14 connected to the wireless interconnecting devices 1-1 to 1-n when the above-mentioned abnormality notification is given from the competition headquarter is explained next with reference to the subroutine flow chart shown in FIG. 10.

When the processing is started, it is judged whether or not an abnormality notification is received (refer to Step S200 in FIG. 10). When it is judged that the abnormality notification is not received (in a case of NO), this subroutine processing is finished for the moment. Meanwhile, when it is judged that the abnormality notification is received (in a case of YES), the received abnormality information is displayed on a display section (not shown) of the terminal equipment 14 (refer to Step S202 in FIG. 10).

Next, the abnormality information is notified to cellular phones (not shown) carried by the lookouts whose numbers are stored in advance in the terminal equipments 14 (refer to Step S204 in FIG. 10).

Therefore, it is appropriate that the cellular phones carried by the lookouts are provided with a mail receiving function or a data communication function.

Meanwhile, telephone numbers of the cellular phones carried by the plural lookouts are stored in advance in the terminal equipments 14. The terminal equipments 14 transmit the previously received abnormality information as mails or certain data for data communication to each of the telephone numbers in sequence via the telephone adapters 16 when they receive the abnormality notification via the wireless interconnecting devices 1-1 to 1-n.

As a result, the lookouts can be notified of the registration number (in other words, a number on a number cloth worn by the runner) of the runner who has heartbeat or blood pressure abnormality by the mail transmitted to their cellular phones, so that they can take an immediate action for finding the runner who may be running near them.

Incidentally, in the embodiment of the present invention, the individual information obtained by the individual information obtaining device 51 is transmitted to the data processing section 52 by electromagnetic induction, but the present invention, of course, does not need to be limited to this structure and a generally and conventionally known signal transmission system using an electromagnetic wave and the like may also be used.

Furthermore, the sensors for obtaining the physiological information, of course, does not need to be limited to the heartbeat sensor 7 and the blood pressure sensor 8, and a sensor for obtaining other physiological information, for example, temperature and so on, may also be added.

Moreover, the router 3 is used in the wired LAN in the competition headquarter, but a switch and the like may also be used.

Furthermore, in the embodiment of the present invention, a marathon is taken for example as a sport to which the present invention is applied, but the present invention does not need to be limited to this application. It is also applicable to a competition of, for example, golf and so on.

As described hitherto, according to the present invention, individual athletes are made to wear the individual information obtaining devices and information obtained by the individual information obtaining devices is stored in the administrative server via the wireless interconnecting devices so that information on each of the athletes can be concentratedly managed, an activity condition of each of the athletes can be judged based on the collected data, and processing as required can be executed, and thereby, the effect is brought about that efficient management of information on participating athletes in a sport event and efficient running of the sport event are realized.

Furthermore, the effect is brought about that careful management of physical conditions and accident prevention for participants in a sport event can be realized without fail by the concentrated management of information on each of the athletes.

Moreover, the effect is brought about that abnormality in participants' physical conditions during and after a sport event can be detected without delay by the concentrated management of information on the athletes so that reliable safety measures can be realized.

What is claimed is:

1. A sport information monitoring system using a wireless interconnecting device, comprising:
an individual information obtaining device which is worn by an athlete, for obtaining individual information on the athlete;
a plurality of wireless interconnecting devices for wirelessly interconnecting the individual information obtained by said individual information obtaining device;
an administrative server for storing the individual information obtained by said individual information obtaining device via said plural wireless interconnecting devices; and
an administrative computer for judging an activity condition of the athlete based on the individual information stored in said administrative server.

2. A sport information monitoring system using a wireless interconnecting device according to claim 1, further comprising:
a data processing section for receiving and processing a signal transmitted from said individual information obtaining device.

3. A sport information monitoring system using a wireless interconnecting device according to claim 2, further comprising:
a terminal equipment provided with a transmitting function of transmitting the individual information from said individual information obtaining device, which is received and processed by said data processing section, to said wireless interconnecting devices.

4. A sport information monitoring system using a wireless interconnecting device according to claim 3,
wherein said individual information obtaining device includes a sensor for obtaining physiological information on the athlete and is provided with a transmitting function of transmitting corresponding data to an external part.

5. A sport information monitoring system using a wireless interconnecting device according to claim 4,
wherein said plural wireless interconnecting devices are realized by wireless access points installed in a plurality of places to constitute a wireless LAN.

6. A sport information monitoring system using a wireless interconnecting device according to claim 5,
wherein the individual information obtained by said individual information obtaining device is transmitted to said administrative server by packet transfer through the wireless LAN.

7. A sport information monitoring system using a wireless interconnecting device according to claim 6,
wherein the individual information includes data on blood pressure and heartbeat.

8. A sport information monitoring system using a wireless interconnecting device according to claim 7,
wherein the individual information is made to correspond to a registration number of the athlete.

9. A sport information monitoring system using a wireless interconnecting device according to claim 8,
wherein said administrative computer judges existence and nonexistence of abnormality based on comparison of a reference value set for each individual with the data on blood pressure and heartbeat of each individual stored in said administrative server.

10. A sport information monitoring system using a wireless interconnecting device according to claim 9,
wherein, when it is judged that the abnormality exists at least in either one of the heartbeat or the blood pressure, said administrative computer transmits information to that effect via said wireless interconnecting device connected to said administrative computer to other ones of said wireless interconnecting devices.

11. A sport information monitoring system using a wireless interconnecting device according to claim 10,
wherein, when said terminal equipment receives the information indicating that the athlete has the abnormality in his physical condition from said administrative computer via said wireless interconnecting device, the terminal equipment transmits the information to a place stored in advance as a place to which the information is to be notified.

12. A wireless interconnecting device used for a sport information monitoring system for obtaining and monitoring individual information on each participant in a sport,
wherein the wireless interconnecting device is realized by a wireless access point to be an element constituting a wireless LAN.

13. A wireless interconnecting device for a sport information monitoring system according to claim 12,
wherein the wireless interconnecting device for a sport information monitoring system is installed in plurality and packet transfer by the plural wireless interconnecting devices for the sport information monitoring system enables individual information to be transmitted to a wireless interconnecting device for the sport information monitoring system connected to an administrative server.

14. A wireless interconnecting device for a sport information monitoring system according to claim 13,
wherein the individual information includes data on heartbeat and blood pressure.

15. A wireless interconnecting device for a sport information monitoring system according to claim 14,
wherein the individual information is made to correspond to a registration number of the participant.

16. An individual information obtaining device used for a sport information monitoring system for obtaining and monitoring individual information on each participant in a sport, comprising:
sensors for obtaining physiological information of the participant.

17. An individual information obtaining device for a sport information monitoring system according to claim 16,
wherein said sensors are a heartbeat sensor and a blood pressure sensor.

18. An individual information obtaining device for a sport information monitoring system according to claim 17,
wherein data on heartbeat and blood pressure are made to correspond to a registration number of the participant to form the individual information.

19. An individual information obtaining device for a sport information monitoring system according to claim 18, further comprising,
a transmitter for transmitting detected signals of the heartbeat sensor and the blood pressure sensor to an external part.
